(19) United States
(12) Patent Application Publication
(10) Pub. No.: US 2013/0322007 A1
(43) Pub. Date: Dec. 5, 2013

(54) DATA STORAGE DEVICE ASSEMBLY

(71) Applicant: CHUNG-HSING YANG, Tu-Cheng (TW)

(72) Inventor: CHUNG-HSING YANG, Tu-Cheng (TW)

(73) Assignee: HON HAI PRECISION INDUSTRY CO., LTD., Tu-Cheng (TW)

(21) Appl. No.: 13/528,935

(22) Filed: Jun. 21, 2012

(30) Foreign Application Priority Data
May 30, 2012 (TW) 101119361

(51) Int. Cl. G06F 1/16

(52) U.S. Cl. 361/679.31

(57) ABSTRACT

A data storage device assembly includes a first data storage device, a second data storage device, a bracket, and a circuit board. The bracket includes a first clamping portion, a second clamping portion, and a connecting portion. The first clamping portion and the second clamping portion extend from the connecting portion and are located on two opposite sides of the connecting portion. The circuit board is secured to the bracket. The first data storage device is secured to the first clamping portion and electronically connected to the circuit board. The second data storage device is secured to the second clamping portion and electronically connected to the circuit board.

### BACKGROUND

1. Technical Field

The present disclosure relates to data storage device assemblies, and particularly to a data storage device assembly having a bracket.

2. Description of Related Art

Notebook computers typically include a hard disk and a CD-driver. The hard disk and the CD-driver are separately secured to two brackets with screws. The two brackets are then installed on base of the notebook computer with screws. Assemblies or disassemblies of the hard disk and the CD-driver are very time-consuming and inconvenient. It is costly to provide the hard disk and the CD-driver with two pairs of plate terminals and cable terminal for electronically connecting the hard disk and the CD-driver to a motherboard of the notebook computer.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a data storage device assembly in accordance with an embodiment, the data storage device assembly including a bracket, a circuit board, a first data storage device and a second data storage device.

FIG. 2 is a partially assembled view of the data storage device assembly of FIG. 1, and the circuit board being secured to the bracket.

FIG. 3 is similar to FIG. 2, but viewed from different aspect.

FIG. 4 is an assembled view of the data storage device assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

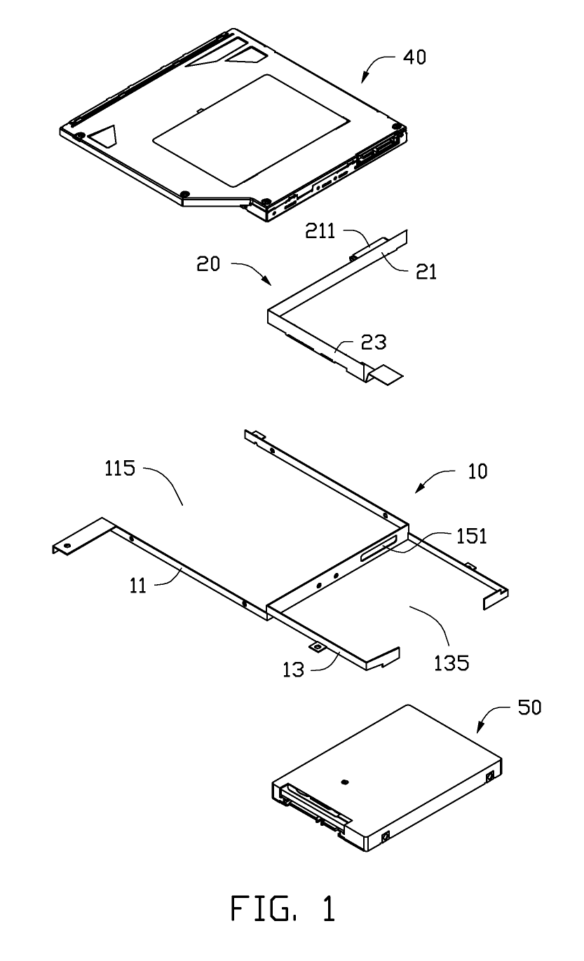

Referring to FIG. 1, a data storage device assembly of an embodiment, includes a bracket 10, a circuit board 20, a first data storage device 40, and a second data storage device 50. For example, the first data storage device 40 may be a CD-drive, and the second data storage device 50 may be a hard disk or a floppy disk drive. In one embodiment, the circuit board 20 is flexible printed circuit board.

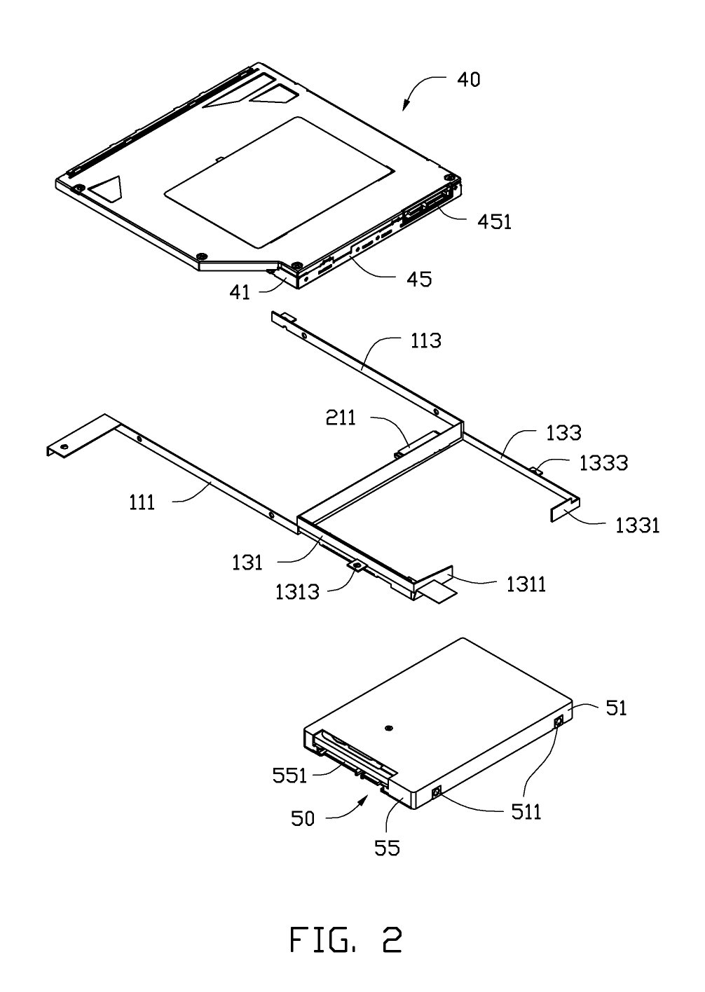

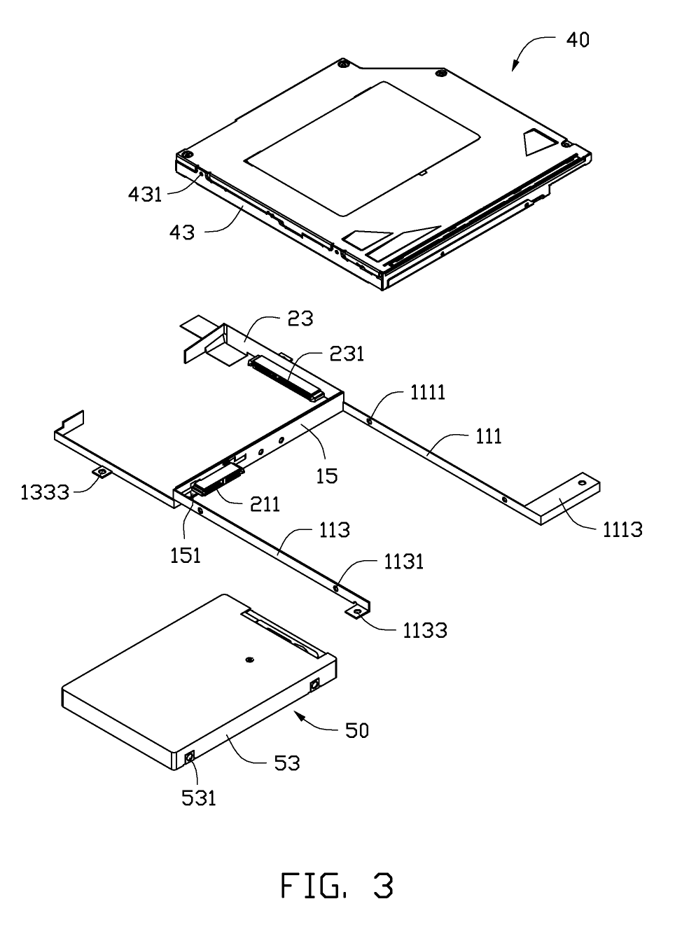

Referring to FIGS. 2 and 3, the bracket 10 includes a first clamping portion 11, a second clamping portion 13, and a connecting portion 15. The first clamping portion 11 and the second clamping portion 13 extend from the connecting portion 15 and are located on two opposite sides of the connecting portion 15.

The first clamping portion 11 includes a first clamping piece 111 and a second clamping piece 113. The first clamping piece 111 and the second clamping piece 113 separately extend from two opposite ends of the connecting portion 15. In one embodiment, the first clamping piece 111 is substantially parallel to the second clamping piece 113 and substantially perpendicular to the connecting portion 15. The first clamping piece 111, the second clamping piece 113 and the connecting portion 15 cooperatively define a first clamping space 115. The first clamping piece 111 defines two first locking holes 1111. The second clamping piece defines two second locking holes 1131. A first stopping piece 1113 extends outwards from a distal end of the first clamping piece 111. A second stopping piece 1133 extends outwards from a distal end of the second clamping piece 113. A through hole 151 is defined in the connecting portion 15 adjacent to the second clamping piece 113. The connecting portion 15 defines a stopping hole (not shown) adjacent to the through hole 151.

The second clamping portion 13 includes a third clamping piece 131 and a fourth clamping piece 133. The third clamping piece 131 and the fourth clamping piece 133 extend from two opposite ends of the connecting portion 15. In one embodiment, the third clamping piece 131 is substantially parallel to the fourth clamping piece 133 and is substantially perpendicular to the connecting portion 15. The third clamping piece 131, the fourth clamping piece 133 and the connecting portion 15 cooperatively define a second clamping space 135. The third clamping piece 131 is located above the first clamping piece 111. The fourth clamping piece 133 is placed above the second clamping piece 113. A first tab 1311 extends inwards from a distal end of the third clamping piece 131. A first fixing piece 1313 extends outwards from outer surface of the third clamping piece 131. A second tab 1331 extends inwards from a distal end of the fourth clamping piece 133. A second fixing piece 1333 extends outwards from outer surface of the fourth clamping piece 133. In one embodiment, the first tab 1311 and the first fixing piece 1313 are substantially perpendicular to the third clamping piece 131, the second tab 1331 and the second fixing piece 1333 are substantially perpendicular to the fourth clamping piece 133. A latch hole (not shown) is defines in each of the first tab 1311 and the second first tab 1331. A fixing hole (not labeled) is defined in each of the first fixing piece 1313 and the second fixing piece 1333, for receiving a fastener to secure the bracket 10 to a notebook computer.

The circuit board 20 includes a first portion 21 and a second portion 23. In one embodiment, the first portion 21 is substantially perpendicular to the second portion 23. The first portion 21 has a first connector 211 configured to electronically connect with the first data storage device 40. The second portion has a second connector 231 configured to electrically connect with the second data storage device 50.

The first data storage device 40 includes a first sidewall 41, a second sidewall 43 opposite to the first sidewall 41 and a first rear wall 45. Two installation holes 431 are defined in each of the first sidewall 41 and the second sidewall 43. The first rear wall 45 defines a first interface 451 configured to secure the first connector 211.

The second data storage device 50 includes a third sidewall 51, a fourth sidewall 53 and a second rear wall 55. Two first positioning holes 511 are defined in the third sidewall 51. The fourth sidewall 53 defines a second positioning holes 531 far away the second rear wall 55. The second rear wall 55 defines a second interface 551 configured to secure the second connector 231.

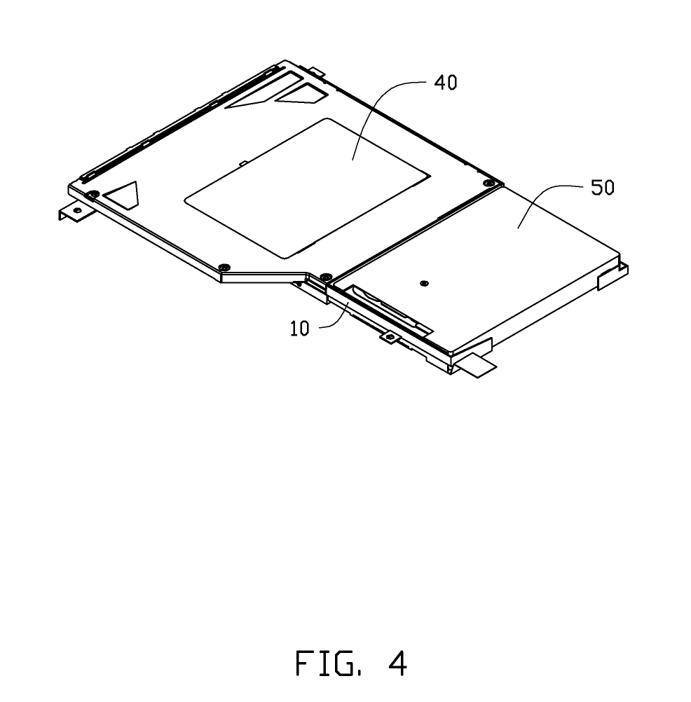

Referring to FIG. 4, in assembly, the circuit board 20 is placed at the second clamping space 135. The first connector 211 extends through the through hole 151 and is exposed on the first clamping space 115. The first portion 211 is plastered on the connecting portion 15. The second portion 23 is pasted on inner surface of the third clamping piece 131. The circuit board 20 is thereby installed on the bracket 10.

In assembly of the first data storage device 40, the first data storage device 40 is pushed towards the connecting portion 15, until the first connector 211 is inserted into the first interface 451. The first sidewall 41 and the second sidewall 43 are sandwiched between the first clamping piece 111 and the second clamping sidewall 113. Each of the two installation holes 431 of the first sidewall 41 is aligned with each of the two first locking holes 1111 of the first clamping piece 111. Two fasteners, such as screws, are screwed into each of the two installation holes 431 and each of the two first locking holes 1111. Each of the two installation holes 431 of the second sidewall 41 is aligned with each of the two second locking holes 1131. Two fasteners, such as screws, are screwed into each of the two installation holes 431 and each of the two second locking holes 1131. The first data storage device 40 is thereby secured to the bracket 10.

In assembly of the second data storage device 50, the second data storage device 50 is place at a side of the fourth clamping piece 133. The second data storage device 50 is pushed towards the third clamping piece 131, until the second connector 23 is inserted into the second interface 551. The third clamping piece 131 and the fourth clamping piece 133 are sandwiched between the first tab 1311, the second tab 1331 and the connecting portion 15. Each of the two first positioning holes 511 is aligned with each latch hole of the first tab 1311 and the second tab 1331. Two fasteners, such as screws, are screwed into each of the two first positioning holes 511 and each latch hole. The second positioning hole 531 is aligned with the stopping hole of the connecting portion 15. A fastener, such a screw, is screwed into the second positioning hole 531 and the stopping hole. The second storage device 50 is thereby secured to the bracket 10.

The data storage device assembly is configured to install to the notebook computer via the first stopping piece 1113, the second stopping piece 1133, the first fixing piece 1313, and the second fixing piece 1333.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A data storage device assembly comprising:
a first data storage device;
a second data storage device;
a bracket, the bracket comprising a first clamping portion, a second clamping portion, and a connecting portion; the first clamping portion and the second clamping portion extending from the connecting portion and being located on two opposite sides of the connecting portion; and
a circuit board secured to the bracket;
wherein the first data storage device is secured to the first clamping portion and electronically connected to the circuit board, the second data storage device is secured to the second clamping portion and electronically connected to the circuit board.

2. The data storage device assembly of claim 1, wherein the first clamping portion comprises a first clamping piece and a second clamping piece; the first clamping piece, the second clamping piece and the connecting portion cooperatively define a first clamping space, and the first data storage device is received in the first clamping space.

3. The data storage device assembly of claim 2, wherein the first clamping piece and the second clamping piece extend from two opposite ends of the connecting portion; the first clamping piece is substantially parallel to the second clamping piece and substantially perpendicular to the connecting portion.

4. The data storage device assembly of claim 3, wherein the first data storage device comprises a first sidewall and a second sidewall opposite to the first sidewall; and the first sidewall and the second sidewall are sandwiched between the first clamping piece and the second clamping piece.

5. The data storage device assembly of claim 2, wherein the second clamping portion comprises a third clamping piece and a fourth clamping piece; the third clamping piece and the fourth clamping piece extend from two opposite ends of the connecting portion;
the third clamping piece is located above the first clamping piece and the fourth clamping piece is located below the third clamping piece.

6. The data storage device assembly of claim 5, wherein the third clamping piece is substantially parallel to the fourth clamping piece and substantially perpendicular to the connecting portion.

7. The data storage device assembly of claim 6, wherein a first tab extends inwards from a distal end of the third clamping piece, a second tab extends inwards from a distal end of the fourth clamping piece; the second data storage device comprises a third sidewall and a fourth sidewall; the third sidewall and the fourth sidewall are sandwiched among first tab, the second tab and the connecting portion.

8. The data storage device assembly of claim 5, wherein the circuit board comprises a first portion and a second portion connected to the first portion; a first connector is located on the first portion, and a second connector is located on the second portion; the first data storage device is electronically connected to the first connector, and the second data storage device is electronically connected to the second connector.

9. The data storage device assembly of claim 8, wherein the first portion is substantially perpendicularly to the second portion.

10. The data storage device assembly of claim 8, wherein the connecting portion defines a through hole, the first connector extends through the through hole to be exposed in the first clamping space; the first portion is attached on the connecting portion, and the second portion is attached on the third clamping piece.

11. A data storage device assembly comprising:
a bracket, the bracket comprising a first clamping portion, a second clamping portion, and a connecting portion; the connecting portion being connected to the first clamping portion and the second clamping portion; the first clamping portion and the second clamping portion being located on two opposite sides of the connecting portion; and
a circuit board secured to the bracket;
wherein the first clamping portion is configured to receive a first data storage device, and the circuit board is configured to be electronically connected with the first data storage device; the second clamping portion is configured to receive a second data storage device, and the circuit board is configured to be electronically connected with the second data storage device.

12. The data storage device assembly of claim 11, wherein the first clamping portion comprises a first clamping piece and a second clamping piece; the first clamping piece, the second clamping piece and the connecting portion cooperatively define a first clamping space, and the first clamping space is configured to receive the first data storage device.

13. The data storage device assembly of claim 2, wherein the first clamping piece and the second clamping piece extend from two opposite ends of the connecting portion; the first clamping piece is substantially parallel to the second clamping piece and substantially perpendicular to the connecting portion.

14. The data storage device assembly of claim 13, wherein the first clamping piece and the second clamping piece are configured to clamp the first data storage device.

15. The data storage device assembly of claim 12, wherein the second clamping portion comprises a third clamping piece and a fourth clamping piece; the third clamping piece and the fourth clamping piece extend from two opposite ends of the connecting portion; the third clamping piece is located above the first clamping piece and the fourth clamping piece is located below the third clamping piece.

16. The data storage device assembly of claim 15, wherein the third clamping piece is substantially parallel to the fourth clamping piece and substantially perpendicular to the connecting portion.

17. The data storage device assembly of claim 16, wherein a first tab extends inwards from a distal end of the third clamping piece, a second tab extends inwards from a distal end of the fourth clamping piece; the first tab, the second tab and the connecting portion are configured to clamp the second data storage device.

18. The data storage device assembly of claim 15, wherein the circuit board comprises a first portion and a second portion connected to the first portion; a first connector is located on the first portion, and a second connector is located on the second portion; the first connector is configured to electronically connect to the first data storage device; and
the second connector is configured to electronically connect to the second data storage device.

19. The data storage device assembly of claim 18, wherein the first portion is substantially perpendicularly to the second portion.

20. The data storage device assembly of claim 18, wherein the connecting portion defines a through hole, the first connector extends through the through hole to be exposed in the first clamping space; the first portion is attached on the connecting portion, and the second portion is attached on the third clamping piece.
